(19) United States
(12) Patent Application Publication
(10) Pub. No.: US 2018/0239173 A1
(43) Pub. Date: Aug. 23, 2018

(54) Optical eyeglasses lens and frame selecting and fitting system and method

(71) Applicant: Michael F. Cuento, Burke, VA (US)

(72) Inventor: Michael F. Cuento, Burke, VA (US)

(21) Appl. No.: 15/870,950

(22) Filed: Jan. 13, 2018

Related U.S. Application Data
(63) Continuation of application No. 13/681,402, filed on Nov. 19, 2012, now abandoned.
(60) Provisional application No. 61/561,260, filed on Nov. 17, 2011.

(51) Int. Cl. G02C 13/00; G06F 3/0484; G06Q 30/06; G02C 7/02

(52) U.S. Cl. CPC G02C 13/005; G06F 3/04842; G02C 7/027; G06Q 30/0631; G06Q 30/0643

(57) ABSTRACT

An optical eyeglasses and frame selection system and method is disclosed. Aspects of the invention assist in eyeglasses lens configurations and frame selection. Also, aspects include customer imaging and simulation of lens and frame options and selections into images. Lens and frame product optical coding may be used by system.

### BACKGROUND OF THE INVENTION

Selecting the right lenses for a specific prescription is a problem in the optical field. Customers tend to spend less time learning about lens type and lens options which often results in customers choosing the cheapest types of lenses. This is problematic as lens quality and prescription compatibility determines visual clarity when buying glasses. In most cases, higher quality and better features are associated with higher prices. Customers usually rush through the lens selection process which is actually the most important part of buying glasses.

Customers also find it difficult to choose the best pair of frames when visiting an optical store. Optical stores either offer too many selections or they do not give enough choices. Sometimes the customer does not know what to look for. The customer must remove his/her glasses when trying on a new frame which can be challenging when deciding on a new frame. The customer also finds it difficult to see what he/she looks like wearing a potential frame when he/she has his/her prescription glasses off and is looking through non-prescription lenses. It is both stressful and time consuming for the customer.

Customers are not the only ones affected by these problems. Every year, optical stores, kiosks and other retail establishments have to account for the losses from returns caused by unwanted glasses. Materials used for frames and lenses are not the only loss a store must account for. Many man-hours go into manufacturing lenses, frames, and selling of these items. Opportunity to make a profit is also lost when customers rush through the lens selection process. Cheaper lenses usually result in lower revenue.

The problems discussed above are due to the insufficient information optical customers are receiving about optical products. Customers usually do not do research before heading to optical stores. Their attention span and willingness to learn about optical products from store associates are also limited. Attempts of retailers and manufacturers to provide optical product related information through multimedia also have limited effectiveness. The present invention relates to new systems, computer program software products and new processes of fitting, buying, selling, and marketing optical related products and services. In exemplary embodiments, a computer hardware and software combination is employed to help both optical customers and product and service providers. Aspects of an exemplary embodiment are illustrated in FIG. 1.

### SUMMARY OF THE INVENTION

According to one embodiment of the present invention, a computer-implemented method for facilitating eyewear selection is provided. The method includes computer-implemented steps of prompting for user information, receiving user input information and presenting eyewear recommendations.

According to another embodiment of the present invention, a system for facilitating eye glasses configuration and selection is presented. The system includes a user computer terminal which includes a display screen, an input device, a processor, and local storage. The processor is configured to execute computer program instructions to cause the computer to prompt the user for information concerning eyewear needs and preferences and to present eyewear recommendations.

According to another embodiment of the present invention, a computer program product stored on a tangible computer readable medium is provided. The computer readable medium contains one or modules of computer program instructions which, when executed by a computer, cause the computer to prompt the user for information concerning eyewear needs and preferences and to present eyewear recommendations.

According to another embodiment of the present invention, a method for providing an eyeglasses customer selection experience is provided. The method involves providing a network connected computer server configured to receive and respond to requests from network connected user computer platforms sent across the network. The method includes a step of transmitting one or more modules of computer executable program instructions and displayable data to a user computer platform in response to a request. The modules are configured to interact with the computer platform user to solicit user data concerning eyeglasses selection and receive and transmit photographic information. In one embodiment, a module is configured to receive advertising information for display to the user and the method may further include a step of transmitting advertising related information to the computer platform and/or receiving advertising related information from a network connected advertising server. In some embodiments, a module may be configured to interact with a social media server.

### BRIEF DESCRIPTION OF THE DRAWINGS

This disclosure is made with reference to the following drawings, in which like features are represented by common reference numbers.

FIG. 1 is an illustrative overview of aspects of an embodiment of the invention.

FIG. 2 illustrates aspects of an exemplary embodiment of the invention employing a table or slate style computer.

FIG. 3 illustrates aspects of an exemplary embodiment wherein customer photos are displayed on a social media networking web page.

FIG. 4 illustrates aspects of an exemplary embodiment of the invention employing a mobile phone.

FIG. 5 illustrates aspects of an exemplary embodiment of the invention employing a laptop computer.

FIG. 6 illustrates aspects of an exemplary retail setting installation according to an embodiment of the invention.

FIGS. 7-11 and 16-17 illustrate exemplary screen shots in accordance with aspects of the invention.

FIG. 12 is an illustrative overview of the frame select feature in accordance with aspects of the invention.

FIG. 13 is an illustrative flow-chart of a frame selection process in accordance with aspects of the invention.

FIG. 14 is an illustrative overview of the frame select feature in accordance with aspects of the invention.

FIG. 15 is an illustrative flow-chart of the photo taking/uploading and sharing processes in accordance with aspects of the invention.

FIG. 18 is an illustrative overview of the lens and lens option selection feature in accordance with aspects of the invention.

FIG. 19 is an illustrative flow-chart of a lens and lens option selection process in accordance with aspects of the invention.

FIG. 20 is a system diagram illustrating aspects of an exemplary embodiment of the invention.

FIG. 21 illustrates an exemplary program module library in accordance with aspects of an embodiment of the invention.

### DETAILED DESCRIPTION OF THE PREFERRED EMBODIMENTS

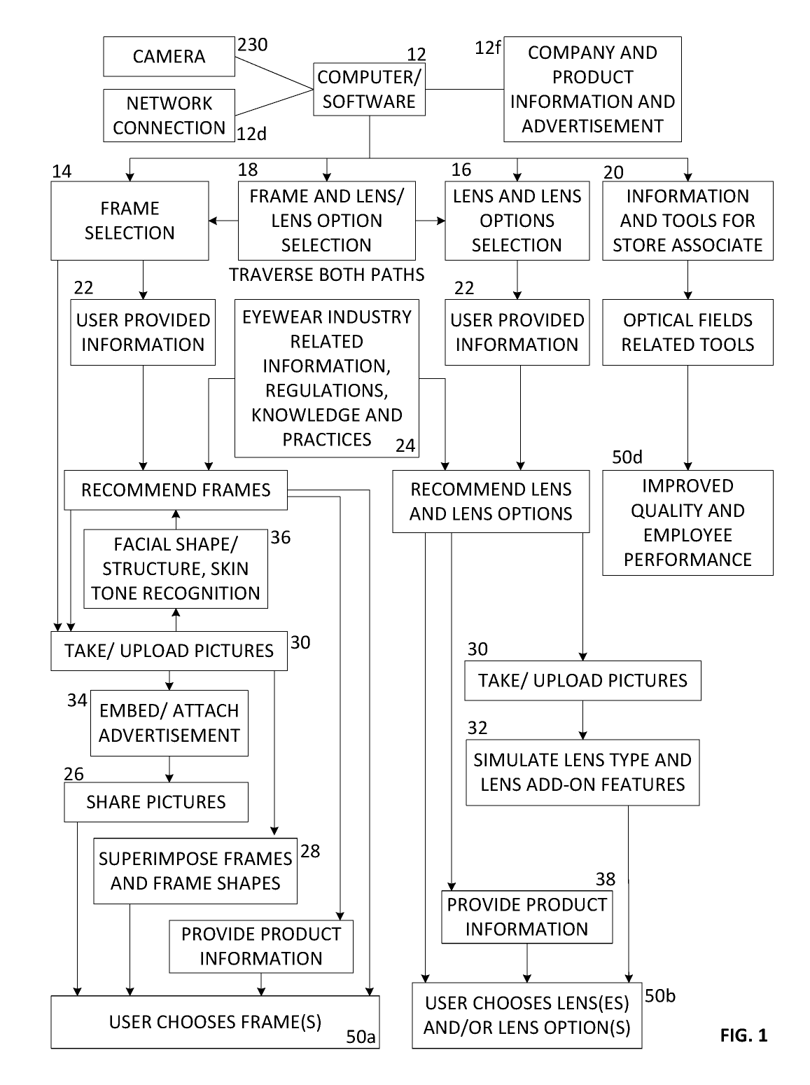

The present invention provides a novel system, method and software product, aspects of which are illustrated in FIG. 1.

An aspect of the invention involves a user interacting with an appropriately configured computer platform 12 to get help with frame selection, optical lens and lens options selection, or a combination of both. In one aspect, the user may have the options of “Frame Selection Feature” 14, “Lens and Lens Options Selection Feature” 16, and/or “Frames, Lens, and Lens Options Selection Feature” 18. In each option, the user may provide information 22 and receive recommendations based on optical industry standards, regulations, knowledge and practices 24 to achieve a desirable result of the selected option (e.g., 50a and/or 50b). The computer platform may be configured with the software for providing further information on any product related recommendation 38.

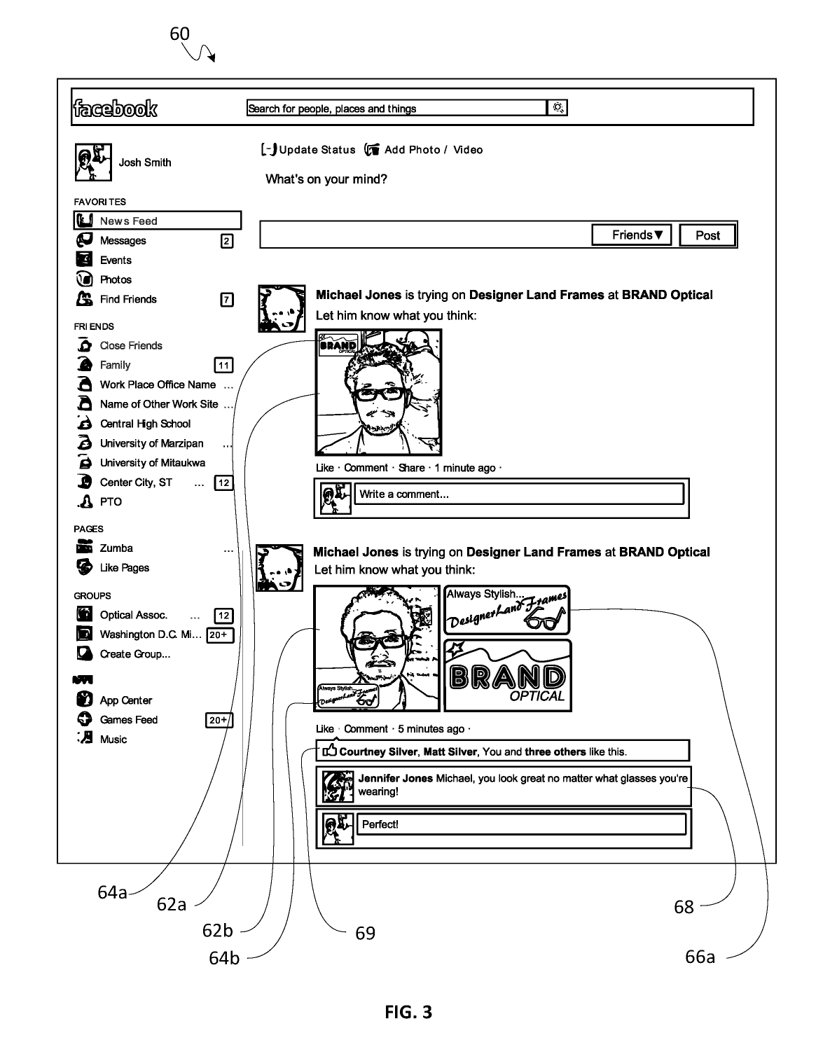

The computer platform may also be equipped with a camera 230 to allow the user to take pictures 30 of himself/herself while trying on a pair of eyeglass frames. A photo of an eyeglasses customer or patient may also be uploaded via removable media or a network connection. This feature would assist one person to shop for or select eyeglasses for another person. This computer platform may also be configured to allow picture sharing 26. For example, pictures may be sent to mobile phones and mobile devices via a network connection 12d to enable users to involve others (e.g., spouse, parent, friend) in the selection of optical products. Pictures taken may be, for example, shared as an email attachment, text message, or posted online in social networking media and other internet websites as shown in a web page 60 in exemplary illustration in FIG. 3. For example, a user using the system may photograph himself using features of the invention and select to share the photographs with his facebook friends so that the photos 62a and 62b are posted to his friends' news feeds. Photo 62a may be stamped with store brand logo 64a and photo 62b may be stamped with eyeglass designer brand 64b. Larger logos, e.g., 66a, may be posted in connection with posting of photos 62a and 62b. The user may receive immediate feedback regarding his candidate eyewear selections such as comments 68 and “Likes” 69. In one aspect, this feature may help optical companies improve product and service awareness as pictures sent may be stamped with information about companies and/or their services 34.

Frame shapes and frames (whether or not available in store) may also be superimposed on a photo of the user's face 28. Automated frame recommendations may also be done based on the analysis of the user's facial shape/structure and skin tone 36. The computer factors in geometrical aesthetics before recommending frames for a user's particular facial shape/structure, whereas colorimetric aesthetics are considered prior to the computer recommending a frame color for a user's particular skin tone. In one aspect, the attached camera may be used to capture images of the user and gather further information about the user's appearance. Picture taking 30 may also be used in the Lens and Lens Options Feature 16. A user can take a picture while wearing a frame to let the software simulate certain lens and lens options 32. Camera 230 may also be used as an optical code (e.g., UPC code, QR or other optical code) reader or scanner to allow fast retrieval of product information to be used by the system and/or provided to the user. In some embodiments, a product code scanner is a separate connectable device. An optical code may be associated with an eyeglass frame, a lens product and/or a sales promotion. In one aspect, network connectivity facilitates the computer platform's ability to provide interactive advertising media and allow companies to stream or feed information and advertisements 12f to a user. This further improves product awareness.

This computer and software combination may also include a feature for providing industry related information and tools for optical professionals 20 to retail associates. A single platform having optical related information, regulations, and core knowledge located in one machine helps optical store associates improve their ability to do their jobs 50d. Such information combined with optical related tools, in a single platform will improve the quality of products sold and manufactured by optical companies. Having these information and tools also helps improve a store associate's ability to help customers pick the right frames, lens and lens options 50a and 50b.

Although certain sequences are illustrated in FIG. 1 and other figures, other sequences are within the scope of the various embodiments of the present invention.

The User Interface

In one embodiment of the invention, an interactive electronic shopping experience is provided that can be accessed in-store, at home as a personal computer application or program, remotely though a website or other electronic medium, or as an application for mobile devices. The shopping experience may also be effected with customized computers, digital signage, and other devices optionally having touch activated interfaces. Below are exemplary embodiments:

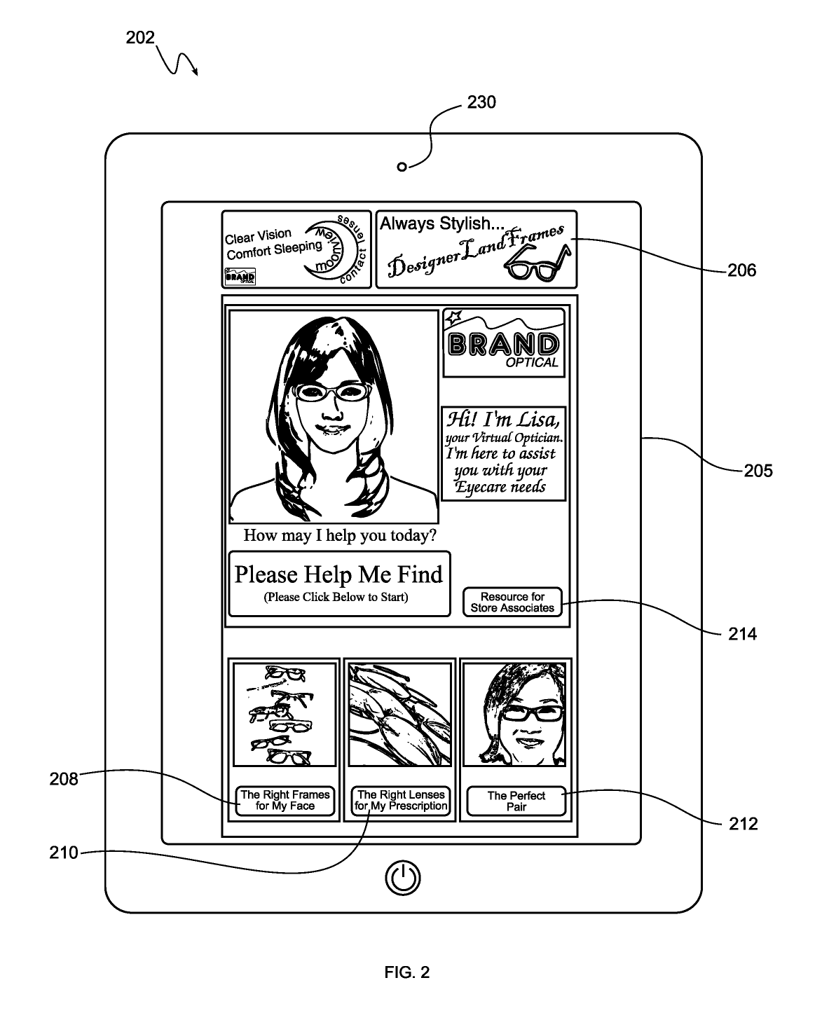

With reference to FIG. 2, aspects of an exemplary embodiment of the invention employing a tablet-style computer (e.g., an Apple iPad, Google Nexus, Amazon Kindle Fire, Microsoft Surface or like) are illustrated. Tablet-style computer 202 includes a camera 230 and a touchscreen display 205. The tablet-style computer is configured to execute computer instructions for displaying information and prompts and receiving input from the user. For example, the display might include advertisements 206 and user prompts for the frame selection feature 208, the lens/lens option selection feature 210, the frames, lens/lens options selection feature 212 and a prompt for the store associate feature 214. Appropriate computer instructions may be provided in the form of an app downloaded to tablet-style computer 202 or may be executed within a browser.

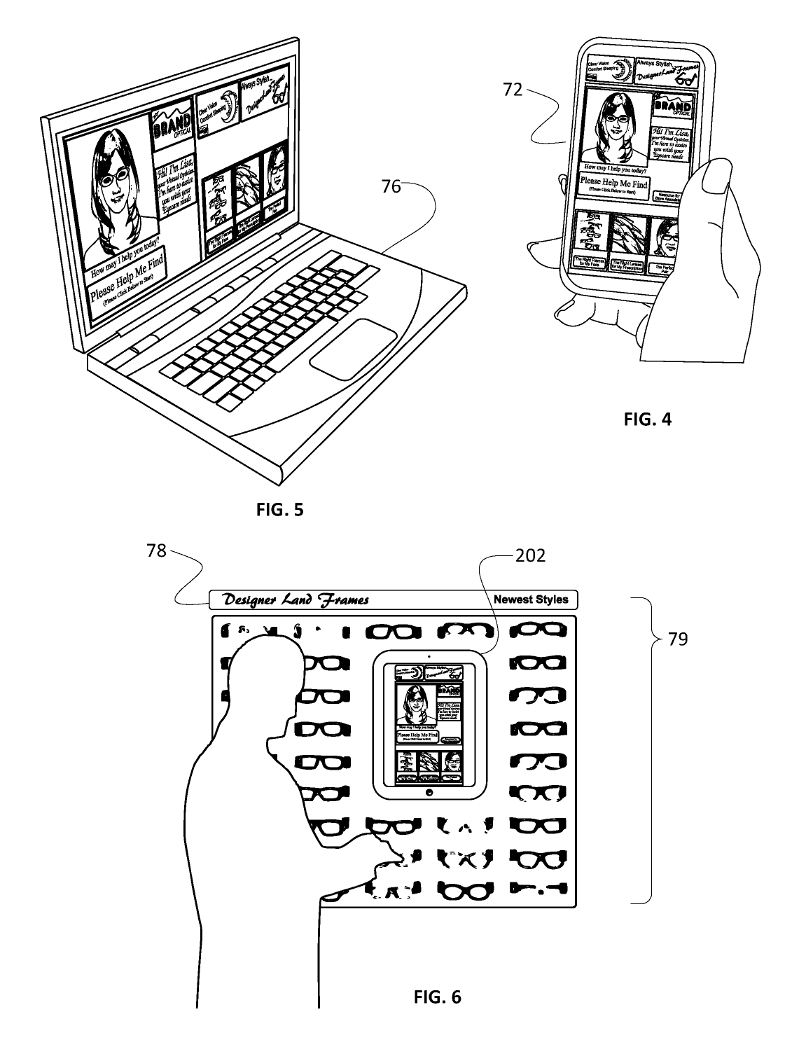

With reference to FIG. 4, aspects of an exemplary embodiment employing a mobile phone 72 are illustrated. Utilizing a mobile phone device 72 in connection with this embodiment would also provide users with portability. Such devices frequently have a built-in camera and network connection and their relatively small size make them ideal for some usage scenarios, such as allowing allow users to go to multiple stores while employing the invention. Appropriate computer instructions may be provided in the form of an application or “app” downloaded to mobile phone 72 or may be executed within a browser running on the mobile phone 72.

With reference to FIG. 5, aspects of an exemplary embodiment employing a laptop computer 76 are illustrated. Utilizing a laptop 76 or a desktop computer would permit both optical professionals and optical customers to use the inventions. Many such computers have built-in cameras and network connections. It would allow customers to do the process of buying optical products at home. Appropriate computer instructions may be provided in the form of applications software loaded to computer 76 or may be executed within a browser or other network connected application.

With reference to FIG. 6, aspects of an exemplary installation in an optical provider or retail setting such as a store or kiosk are illustrated. The process may be used on an appropriately configured computer, tablet 202, or digital signage 78. This would give optical stores the freedom to design hardware that would look, function, and fit in accordance to their business needs and trade dress. For example, an optical store may design a hardware embodiment of the invention that may be modified to be lightweight and mountable to various places in the store. As shown in the example image, the hardware of the process may be located right where customers would try on frames such as display area 79.

The whole process may be integrated with other software related to optical business processes. It may also be used as a standalone point of sale or be connected to other programs.

Frame Selection Feature:

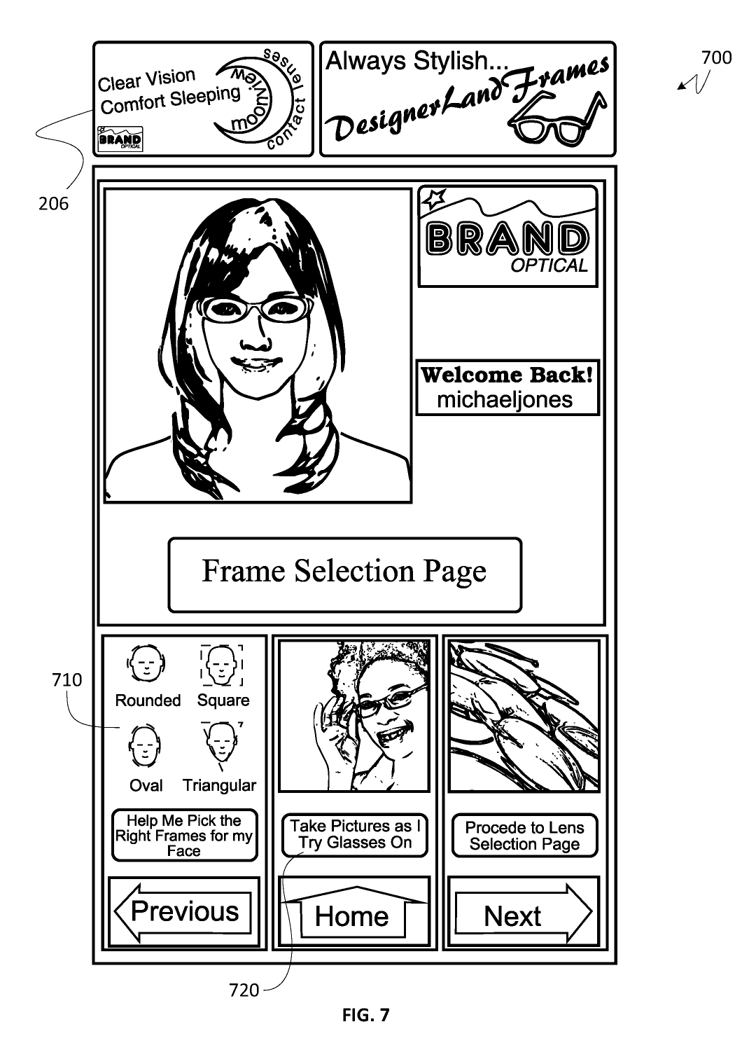

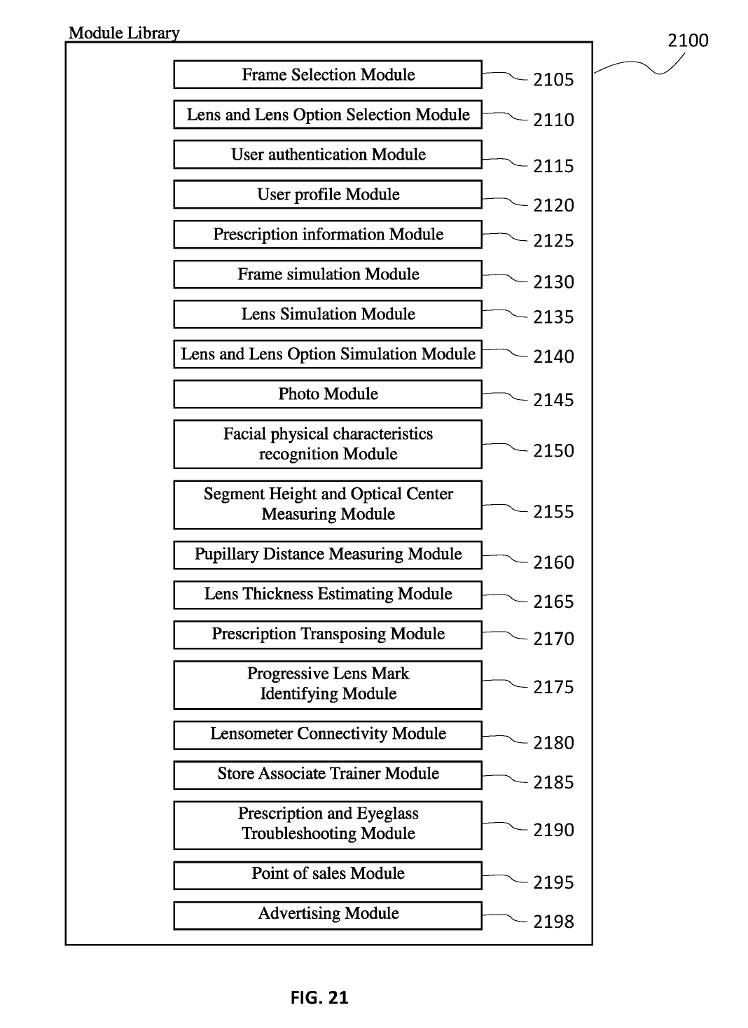

One aspect of the invention is aimed at helping the user with eyeglass frame selection. An exemplary screenshot 700 associated with this feature is shown in FIG. 7. This feature gathers user provided information and makes frame recommendations based on optical industry standards, regulations, knowledge and practices. For example, it may recommend frame shape, size, color, material and style and provide information about frames and frame brands. Frame selection may also be helped or achieved by the use of a camera 230 connected to a computer. Screenshot 700 shows a face shape selection prompt 710 and advertising 206 which may be related or unrelated to the eyewear selection process. Frame Selection Module 2105, see FIG. 21, may contain the software code needed for implementing the Frame Selection Feature.

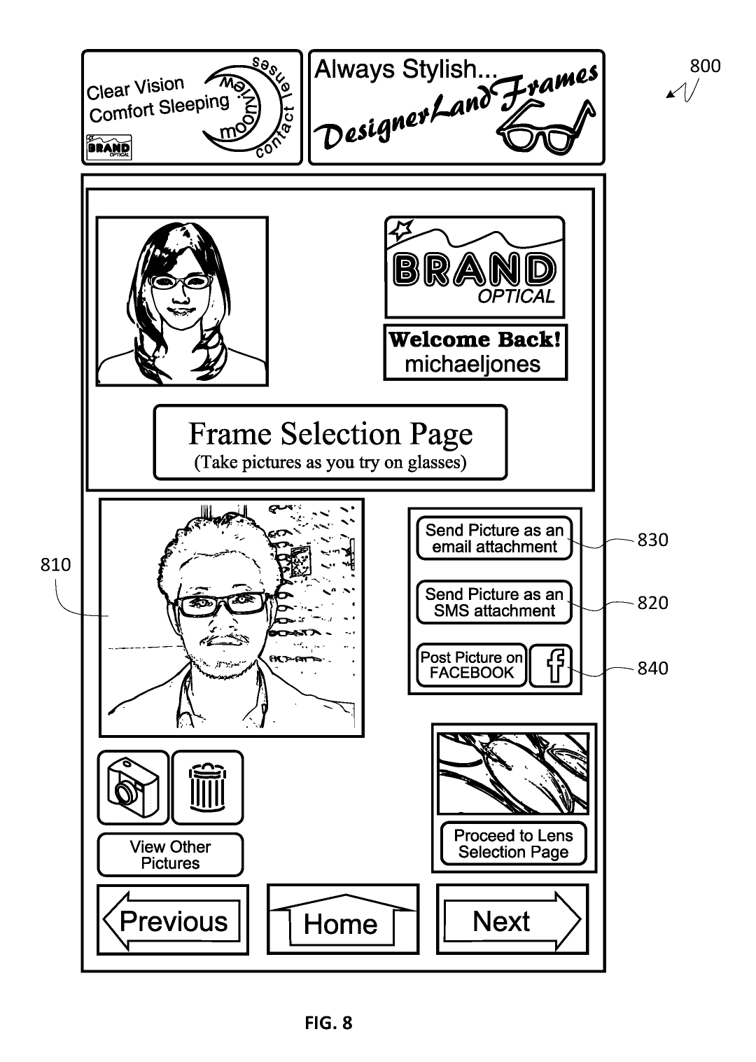

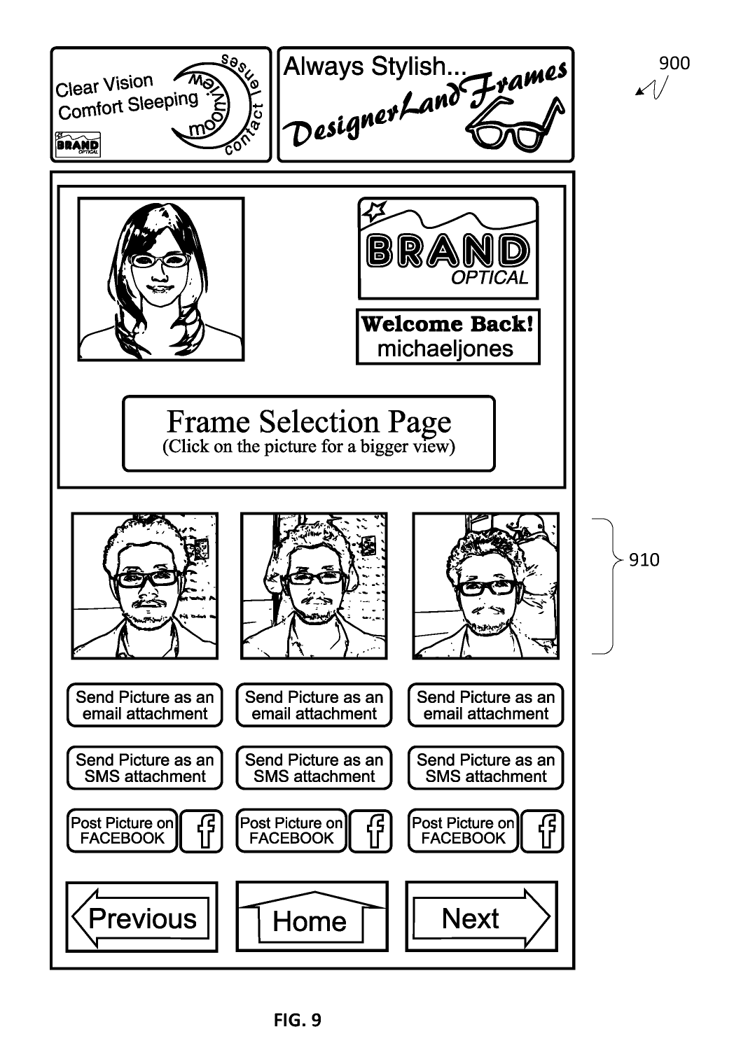

The user may also select the picture prompt 720 to use the camera 230 to take a photo 810 of himself/herself while trying on frames and by using the appropriate buttons, share the photo through text messaging 820, email 830, social networking websites 840 (see, e.g., FIG. 3), or other online posting. An exemplary screenshot 800 associated with this feature is shown in FIG. 8. Having pictures taken while trying on frames allows the user to see himself/herself while wearing glasses and also allows for side by side comparison 910 as illustrated in the exemplary screenshot 900 in FIG. 9. Generic frame shapes and types and frames (whether or not available in the store inventory) may also be superimposed on the user's picture. Picture taking and sharing may also be beneficial to the store as it allows pictures sent to be stamped with store and product information and advertisement. See, for example, photos 62a and 62b as illustrated in FIG. 3. In one embodiment, frame selection may also be done through the use of a facial shape/structure recognition tool included in the computer platform. Such a tool can be configured to detect the user's facial shape and structure and make recommendations for the most appropriate frame shape, size, material and style. Such a tool can also be configured to recognize skin tone information which may be used to make frame color recommendations.

Creating a Profile:

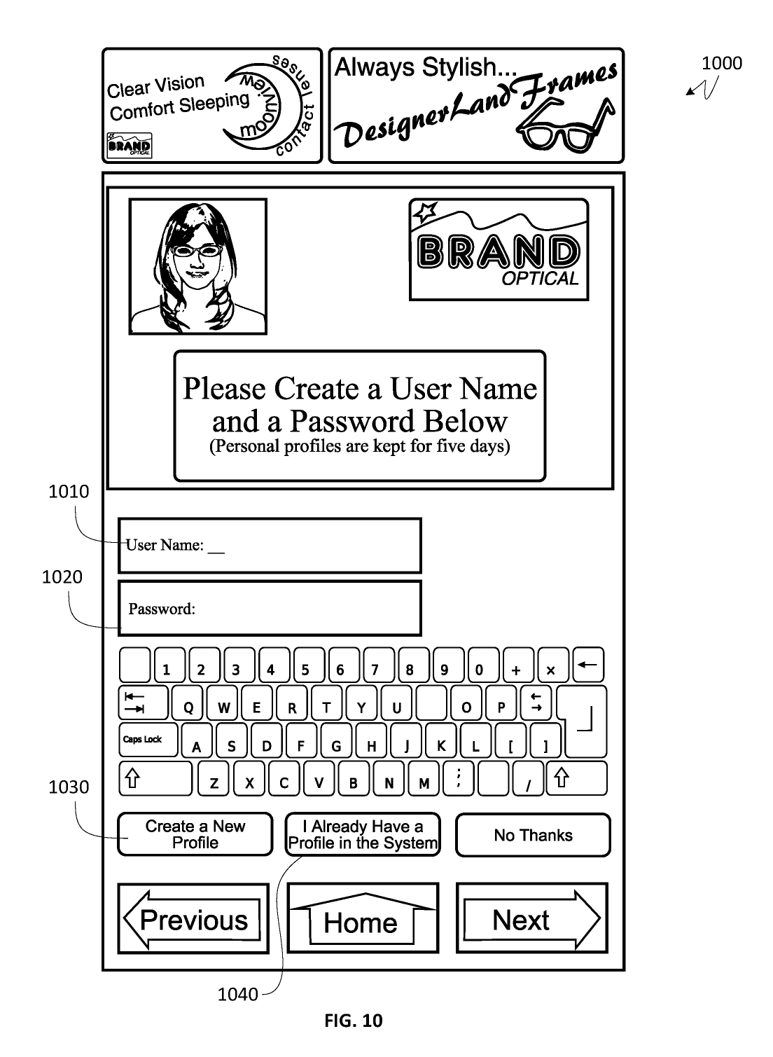

Optionally, by selecting the appropriate prompt during frame selection, the user may be may start a new profile 1030 or access a previously created profile 1040 by providing a user name 1010 and password 1020 as illustrated in the sample screenshot 1000 of FIG. 10. Access credentials may also be provided via a centralized login resource (e.g., Facebook, Google, Yahoo!). Creating a profile would allow the user to access stored pictures and information at a later time and/or a different location. This would also allow optical companies access to useful information about optical costumers. Creating a profile may be done by a customer or with a help of a store associate.

User Provided Information:

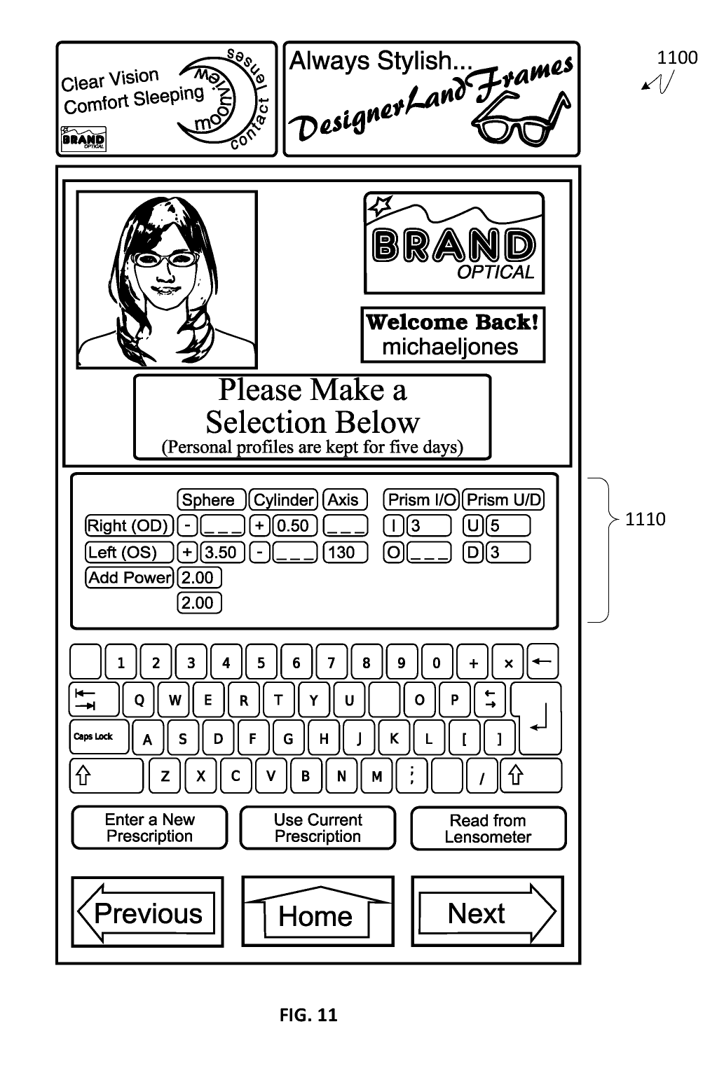

To help in frame selection, the user may be prompted to input information such as an optical prescription. A screen or a series of screens having optical prescription entry area 1110 may be provided to allow the user to enter a prescription or multiple prescriptions. An exemplary screenshot 1100 for prompting and entering information is shown in FIG. 11. This information may be obtained from a recent doctor's prescription or past prescription. The user may also choose from a list of types of prescriptions (e.g., reading, distance, bifocal, trifocal, progressives, etc.) provided and displayed on the screen. This gathered information may be saved in the user's profile for later access to be used to determine frame size, style, material, and shape.

Facial characteristics can be a factor in appropriate frames selection. The user may be asked a series of questions or may choose from a list of physical characteristics to help the feature determine the most suitable frames based on appearance. This information may also be combined with information from the user's prescription to make a more accurate frame recommendation.

To further assist in the frame selection, the user may be prompted to give information about age, gender, personal style preference, lifestyle and activities while wearing eyeglasses. The user may provide this information or choose from a list displayed on the screen. Examples of lifestyle and activities while wearing glasses includes: reading, driving, sports, computer use, gardening, etc.

Photo Assisted Frame Selection:

The user may use an integrated camera or a camera connected to the computer platform to help pick out frames. Photos may also be uploaded or received from a mobile device such as a cellphone or tablet, email, and/or through websites such as Facebook, Yahoo!, Google, etc. The pictures allow the user to see how he/she may look like wearing different frames to compare and pick frame suitability. In one embodiment, an image of the eyeglasses customer wearing simulated frames may be created and displayed. Such frames could be generic frame shapes, particular frames or frames not readily available at the user's present location.

The user may also send pictures to others through phone messaging, via email, social networking websites, and other ways of online posting allowing the user to involve others with frame selection. Pictures sent through the software may be stamped with optical related company and product information and/or other advertisement. Advertisements may be provided by a network connected server.

An optional tool may also determine the user's physical characteristics using automated facial shape/structure recognition and/or skin tone recognition. This feature uses the camera to capture images. The user may also compare his/her facial structure, shape and skin tone with a list generated by the software. Based upon the user's facial shape/structure and skin tone, the computer can provide frame recommendations.

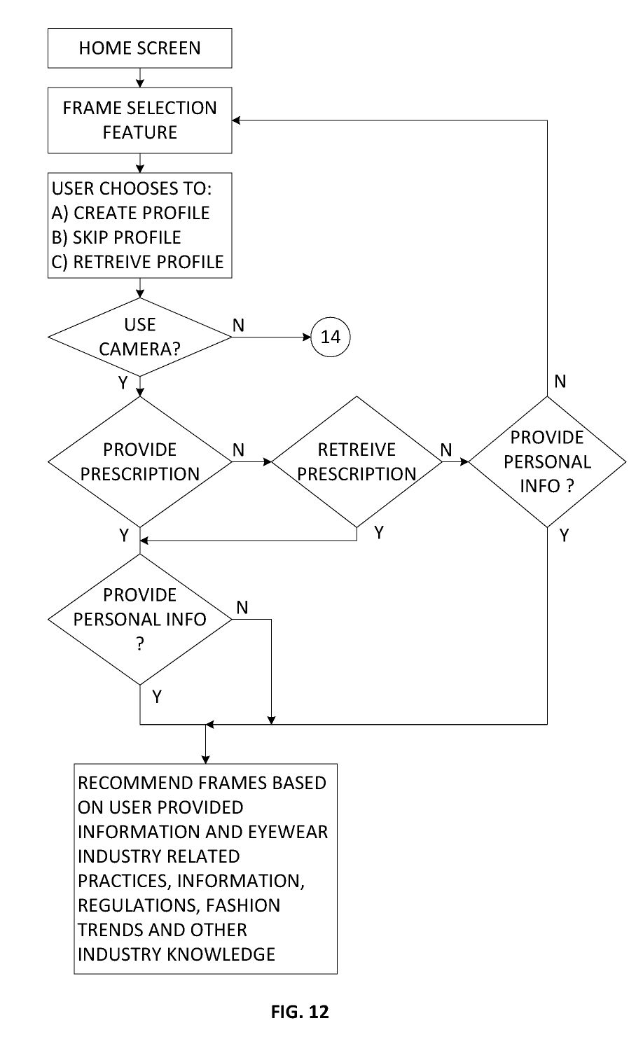

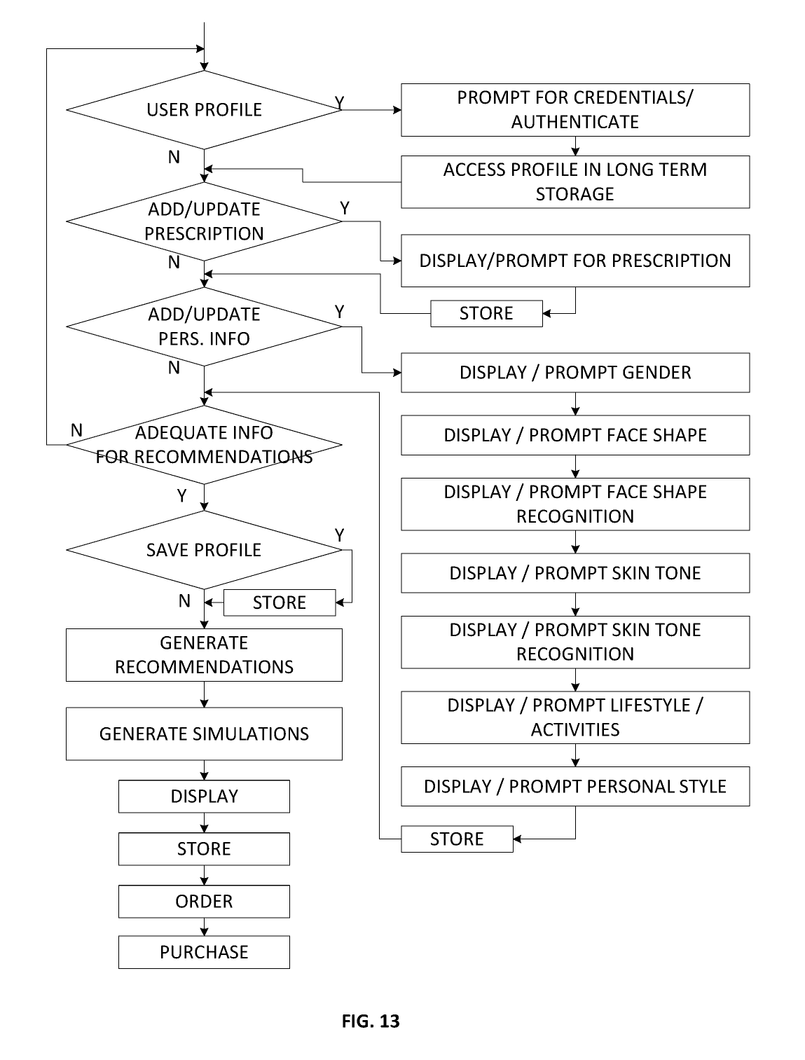

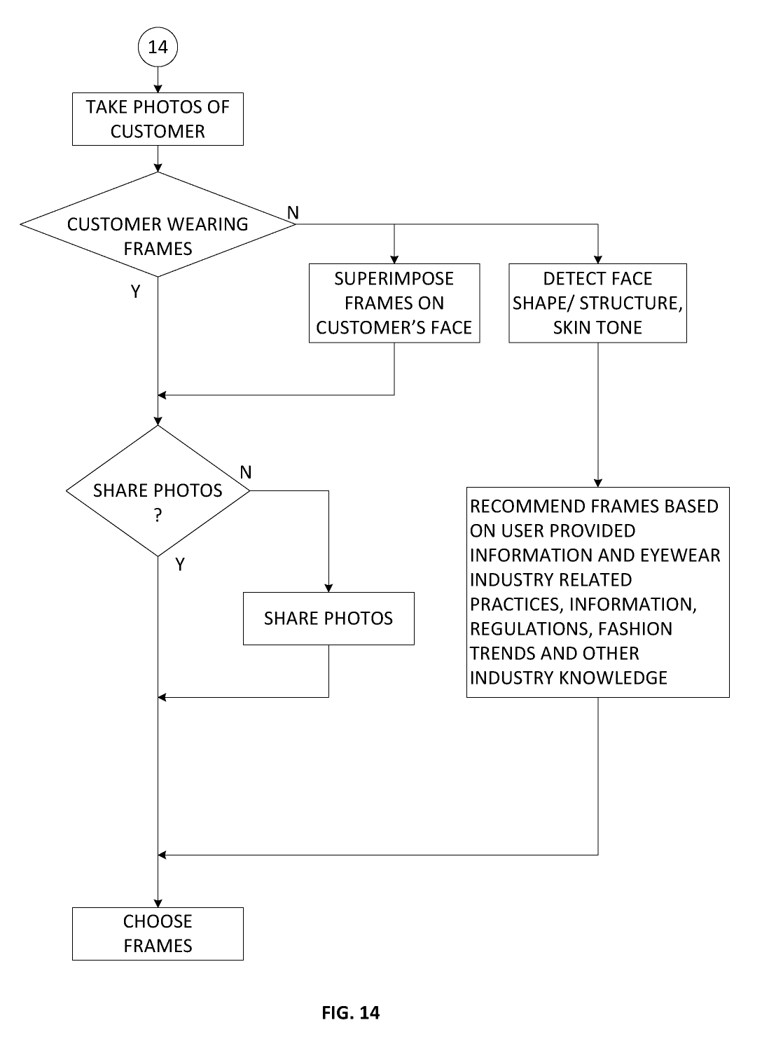

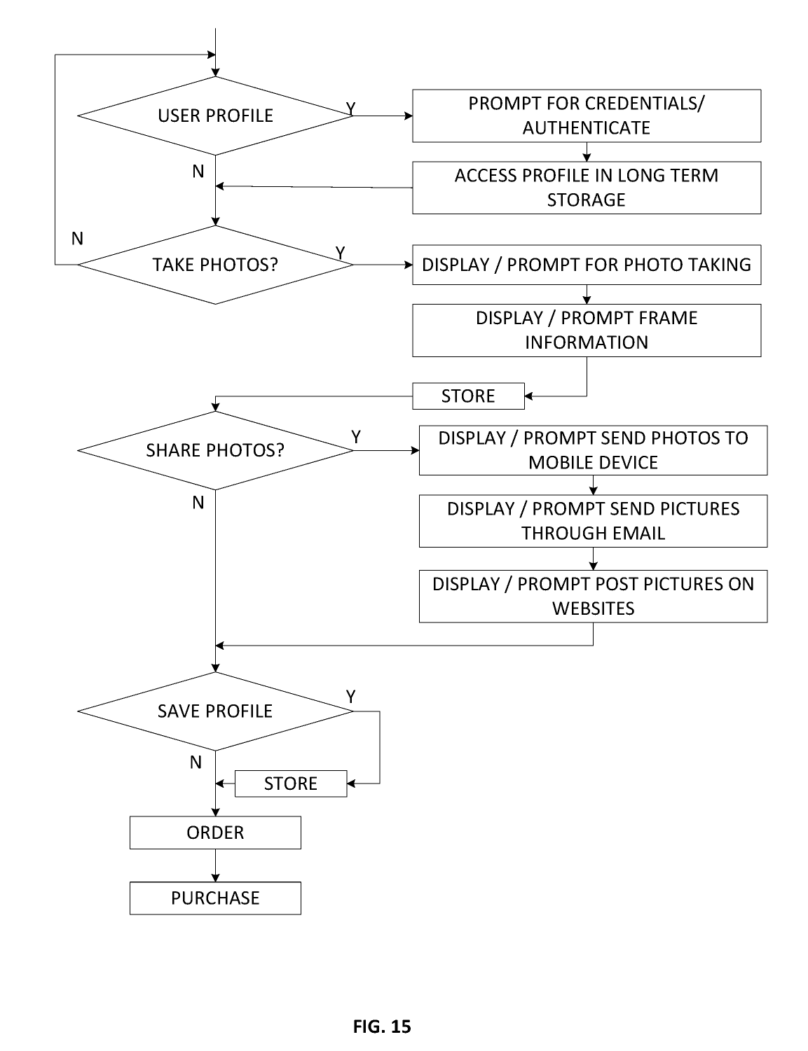

FIGS. 12-15 illustrate exemplary schemas according to embodiments having these features. Note that the order of features may vary and that some are optional.

Lens and Lens Options Feature:

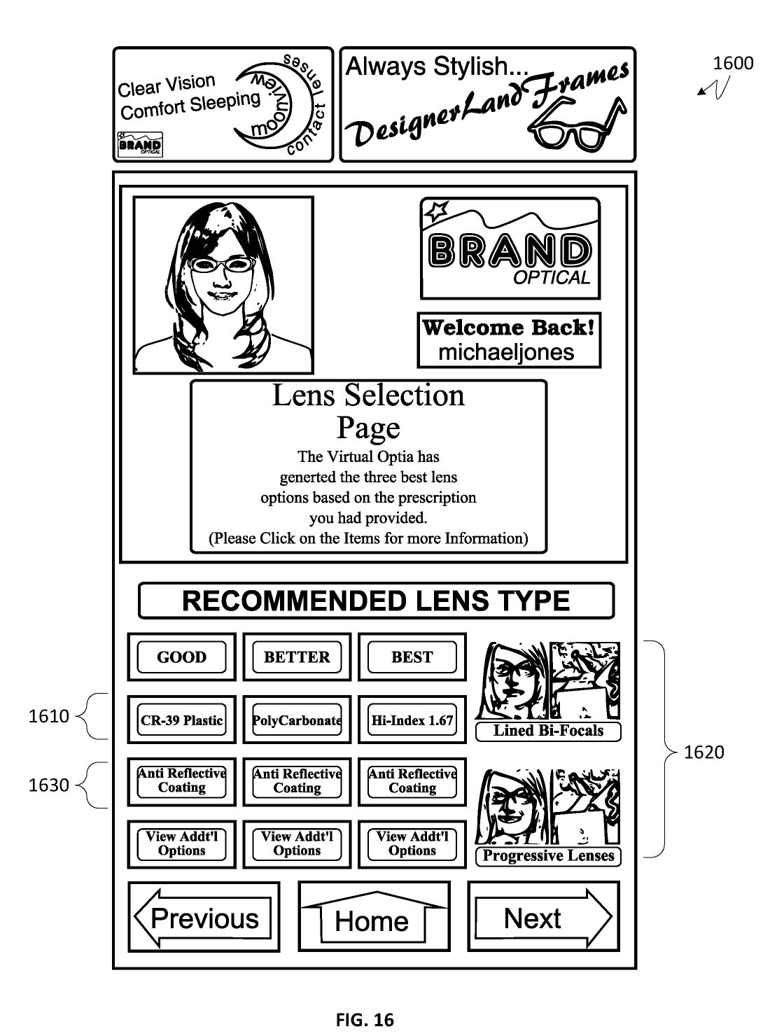

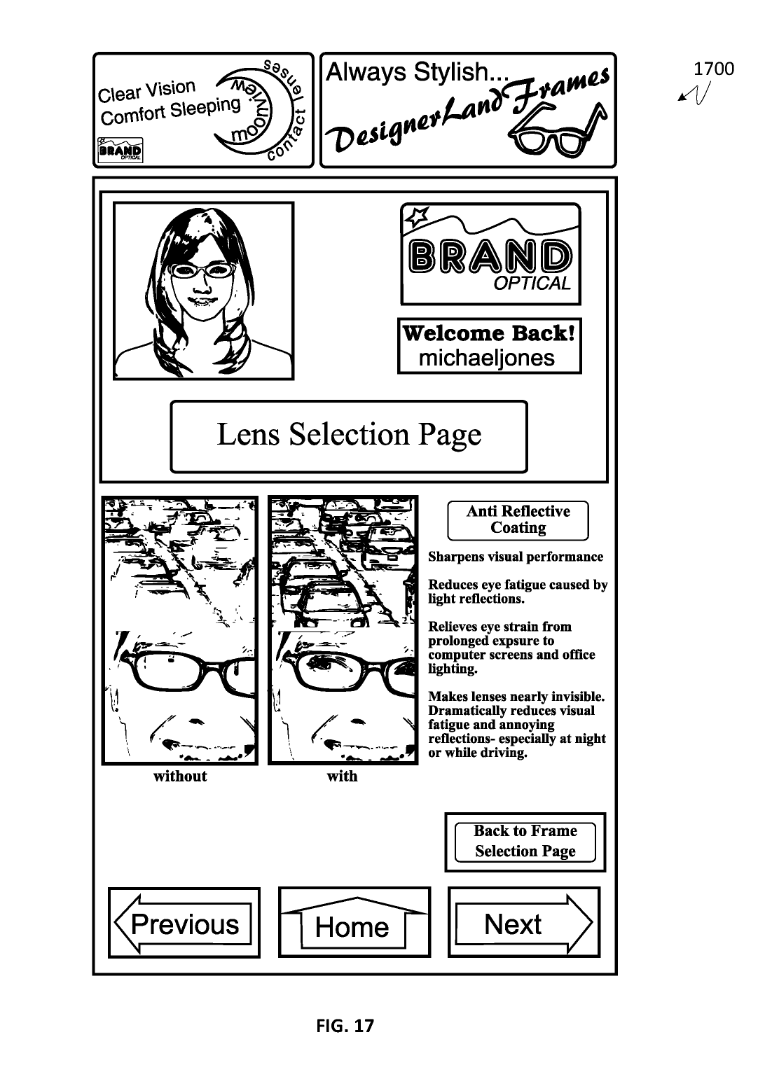

With reference to FIG. 16, in one aspect of the invention, the user may be helped with lens and lens options selection. Exemplary screenshot 1600 illustrates aspects of this feature. This feature may gather user provided information and make recommendations based on optical industry standards, regulations, knowledge and practices. For example, lens type and material (screen area 1610), lens brand, and lens options including, for example, progressives, bifocals or trifocals (screen area 1620), UV protections, tints, polarizations, lens coatings (such as anti-reflective coatings selectable in screen area 1630), photo chromatic, may be recommended. Further information and demonstrations about the recommended lens and lens options may be provided as for anti-reflective coatings as illustrated in screenshot 1700 in FIG. 17. Lens selection may also be achieved by clicking or selecting advertisements and information being fed throughout the software. Examples of these advertisements may be in the form of coupons or special promotions from optical companies. Lens and Lens Option Selection Module 2110, see FIG. 21, may contain the software code for carrying out the Lens and Lens Options Feature.

Creating a Profile:

In one aspect of lens selection, the user may optionally be asked to start a new profile or access a previously created profile. Creating a profile would allow the users to access their information later and/or a different location. This would also allow optical companies access to useful information about optical costumers.

User Information:

To help recommend lens and lens options, the user may be asked a series of questions including, for example, the user's optical prescription. A screen or a series of screens prompts the user to enter a prescription or multiple prescriptions. This information may be obtained from a recent doctor's prescription or an estimate of a current or past prescription. The user may also choose from a list of types of prescriptions provided by the software. This information may be saved in the user's profile for later access.

To further assist in the lens and lens options selection, the user may be prompted to give information about lifestyle and activities while wearing eyeglasses. Different activities require different types of lenses and lens options. For example, a person using a pair of glasses for both night and day may benefit from photo chromatic lenses. Recommendations for a combination of lens features and options may be used based on this and/or other user provided information. The user may provide the information or choose from a displayed list.

Recommendations may also be based on combined optical related information, regulations, and optical industry practices and user provided information. Further information and explanations about these recommendations may also be provided to the user. The user may also take a picture of himself/herself while wearing a frame to allow the software to do a simulation of how different lens options may look like.

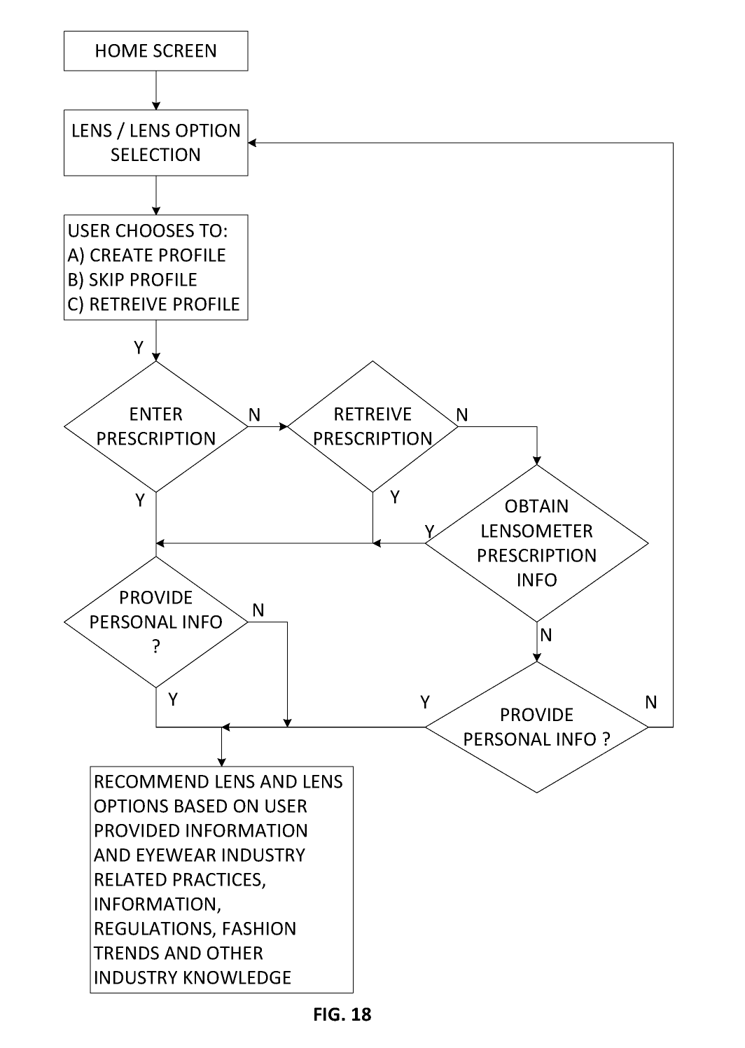

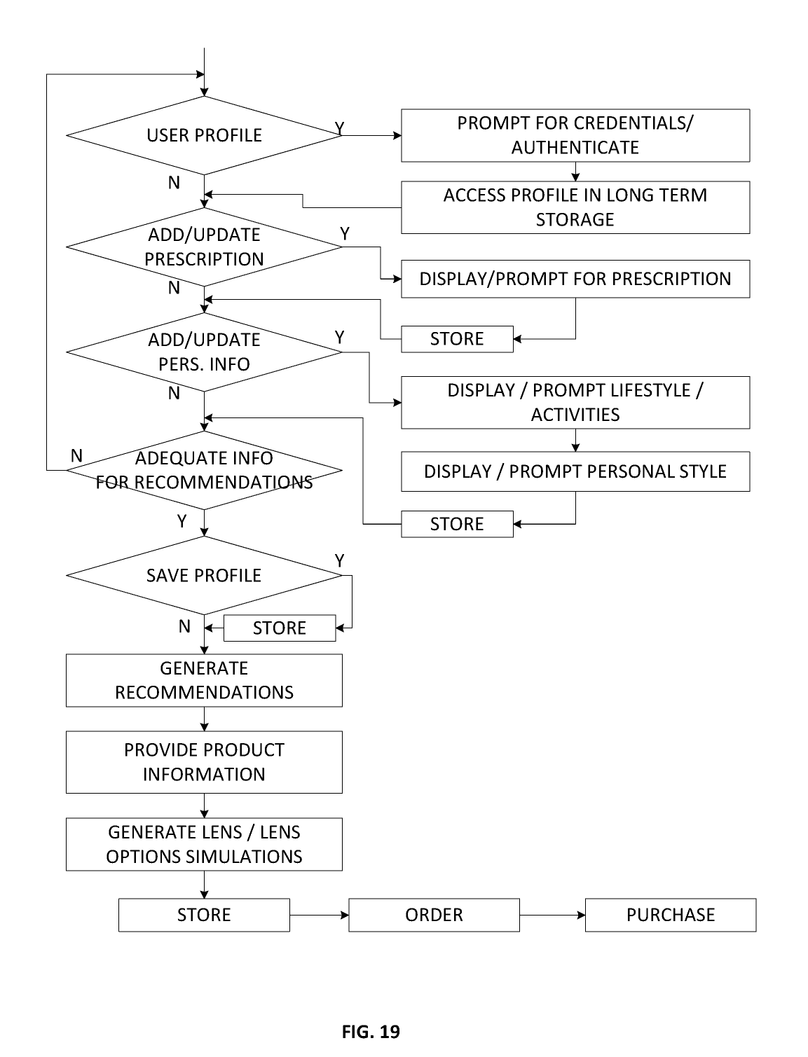

FIGS. 18 and 19 illustrate further detail regarding the lens selection aspect of the invention. Note that the order of features or steps may vary and that some are optional.

Frame, Lens and Lens Options Combination Feature:

The process of picking out frames and the process of picking out lens and lens options may be combined to help with picking out the best pair of glasses for an optical customer.

Optical Employee Section:

This feature provides store associates and optical professionals with industry related information and tools. In one embodiment, optical industry employees may be provided access to optical related information and regulations. This information will be located within the software or may be accessed through the internet. Such information may help optical store associates improve their job capabilities. The computer platform may also include optical related tools such as:

Segment Height and Optical Center Measuring Tool: This tool can be used to measure a person's bifocal, trifocal, and/or progressive lens' segment height as well as a person's optical center. In one embodiment, the camera that is connected to or integrated with the computer platform is used. The location of a person's eyes, pupils, and eyelids are detected and measured in accordance with optical industry standards and regulations.

Pupillary Distance Measuring Tool: This tool can be used to measure a person's pupillary distance. In one embodiment, it is done using the camera that is connected to or integrated with the computer. A picture of a person is taken at a certain distance and then the pupillary distance can be computed in accordance with optical industry standards and regulations.

Lens Thickness Estimating Tool: This is used to estimate and demonstrate lens thickness based on, e.g., calculating an optical lens prescription's curvature, concavity or convexity. Additional information, such as segment height, pupillary distance, material type, frame measurements, and frame type may be used to estimate and/or demonstrate the lenses' center and/or edge thickness.

Prescription Transposing Tool: This is a tool that algebraically transposes optical prescriptions in different forms.

Progressive Lens Mark Identifying Tool: This is a tool that identifies and matches progressive markings for all types and brands.

Lensometer Connectivity: The computer platform may be connected to a lensometer. Lensometers are mainly used by eyewear professionals to verify the correct prescription in a pair of eyeglasses.

Store Associate Trainer: This tool provides associate training in optical related practice, customer service, and other associate required training. Training maybe provided through publications, demonstrations, videos, testing and/or presentations accessed through the computer platform.

Prescription and Eyeglass Troubleshooting Tool: This is a tool used to troubleshoot problems with eyeglasses and prescriptions. It may be in a form of a series of questionnaire or a flowchart that solves an issue. Examples of the issues that may be solved by this feature includes: how to correct a crooked frame, solve eye strain from glasses by adjusting pupillary distance in glasses, or how to lower bifocal segments by adjusting pantoscopic tilt.

Point of sales: The interface may also be used as an interface for sales transactions.

Having these information and tools would also help improve store associates' ability to help customers pick the right frames, lens and lens add-ons.

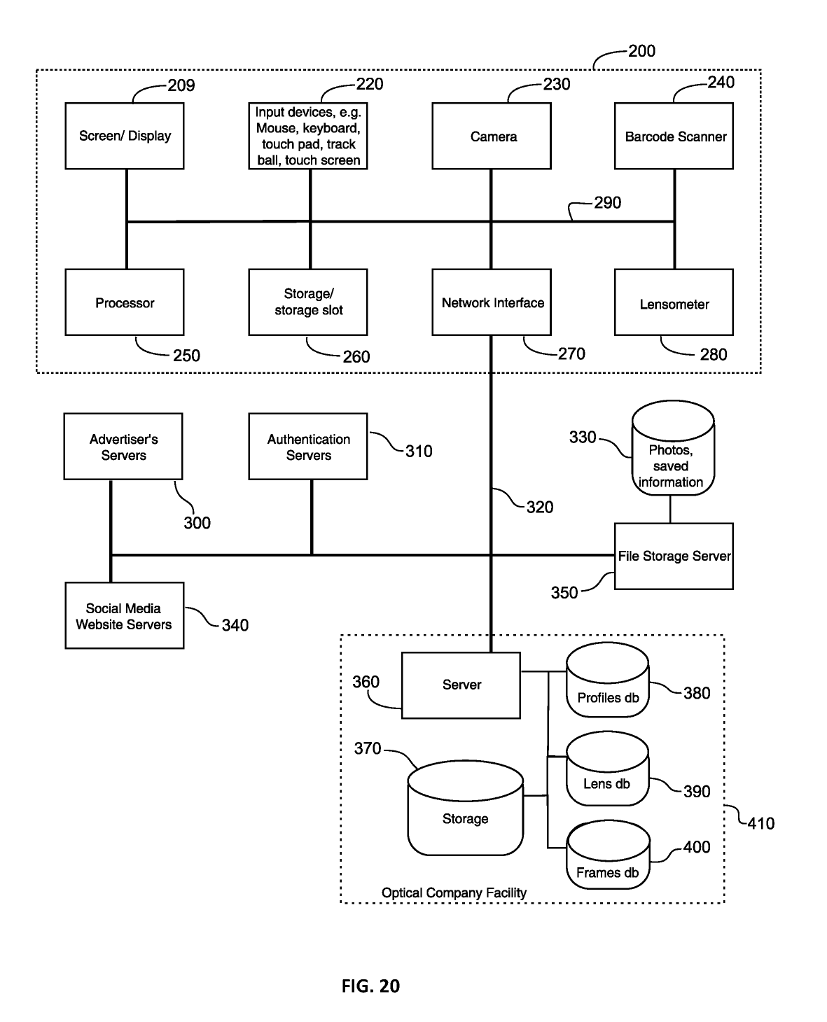

With reference to FIG. 20, aspects of an exemplary system embodiment of the invention are illustrated. For example, a computer platform 200 for user interaction is provided. Computer platform 200 could be, by way of example, iPad2 202, a tablet-style computer, a laptop, or a smart phone. Computer platform includes a display 210, a processor 250, storage 260, and input device 220. Processor 250, storage 260 and other computer platform elements may be interconnected by bus 290. In a preferred embodiment, input device 220 may comprise a touchscreen. Storage 260 may optionally include a storage slot in which removable storage devices may be inserted. In a preferred embodiment, computer platform 200 includes internal camera 230 and network interface 270. Camera 230 may also be an external device connected to computer platform 200. The computer platform is configured with processor executable instructions accessed from storage 260 for carrying out interaction with the user and retrieval and storage of information. Information may be stored via storage/storage slot 260 or may be stored on a network accessible resource such as file storage server 350 and data store 330. Computer platform 200 may optionally include a bar or other optical code reader 240. Bar code scanner 240 may also be any general merchandise scanner such as an RFID scanner. Bar code/optical code scanner 240 may be effected in conjunction with camera 230 or may be an special purpose scanner connected to computer platform 200. Network interface 270 may be a wire-line or wireless network interface.

Computer platform 200 may optionally include or be connected to lensometer 280 to allow lensometer data to be incorporated into the store associates resource features.

Computer platform 200 may be connected via network interface 270 to network 320. Network 320 allows computer platform 200 to communicate with, for example, an authentication server 310, file storage server 350, advertiser server 300 and/or social media server 340. Also, network 320 permits communication with optical company facility 410. Optical company facility 410 may include a server 360 connected with network 320, storage 370 and databases 380, 390 and 400.

Data and computer processor instructions for carrying the inventive methods may be stored on computer platform 200 in, e.g., storage/storage slot 260, file storage server 350, optical company facility server 360, authentication server 310 and/or advertiser server 300. Processor 250, servers 300, 310, 340, 350 and/or 360 may carry out one or more steps of the inventive methods.

With respect to FIG. 21, embodiments of the present invention may employ a library 2100 of software modules containing computer program instructions stored on tangible computer readable media. The media may be one or more storage devices connected to or accessible to computer platform 200 (e.g., storage/storage slot 260) and/or servers 350, 360, 310 and/or 300. Some modules or portions of some modules may be stored persistently in computer platform storage/storage slot 260 for execution by processor 250. Some modules may be transmitted to computer platform 200 upon request or as needed from one or more of servers 350, 360, 310 and/or 300. Some modules or portions of some modules may be executed on one or more of server 350, 360, 310 and/or 300.

Software Module library 2100 may include Frame Selection Module 2105, Lens and Lens Option Selection Module 2110, User authentication Module 2115, User profile Module 2120, Prescription information Module 2125, Frame simulation Module 2130, Lens Simulation Module 2135, Lens and Lens Option Simulation Module 2140, Photo Module 2145, Facial physical characteristics recognition Module 2150, Segment Height and Optical Center Measuring Module 2155, Pupillary Distance Measuring Module 2160, Lens Thickness Estimating Module 2165, Prescription Transposing Module 2170, Progressive Lens Mark Identifying Module 2175, Lensometer Connectivity Module 2180, Store Associate Trainer Module 2185, Prescription and Eyeglass Troubleshooting Module 2190, Point of sales Module 2195 and Advertising Module 2198.

The numerous embodiments described above are applicable to a number of different environments and applications including in-store eyewear selection and at-home eyewear selection. The disclosed system, method and computer medium product also have many additional applications outside these environments and applications that would be apparent to one of ordinary skill in the art.

The embodiments of the invention shown in the drawings and described above are exemplary of numerous embodiments that may be made within the scope of the appended claims. It is contemplated that numerous other configurations of the disclosed system, process, and computer medium product for eyewear marketing, fitting out and retailing may be created taking advantage of the disclosed approaches. It is the applicant's intention that the scope of the patent issuing herefrom will be limited only by the scope of the appended claims.

What is claimed is:

1. A system for optical eyeglasses lens and frame selection and fitting, said system comprising:
a lensometer;
a display screen;
an input device;
a camera;
local storage;
a processor coupled to the lensometer, display screen, input device, camera and local storage; and
computer program instructions stored in the local storage that, when executed by the processor, cause the processor to:
display user prompts on the display screen, said prompts including
prompts to obtain optical lens data from the lensometer for an existing pair of lenses,
prompts to the user to provide an image of the user,
prompts to obtain at least one of a user age, user gender characteristic or user style preference, and
prompts to obtain user lifestyle and activities,
obtain an image of the user via the camera or from an existing image file,
receive user responses to the prompts via the input device,
receive the optical lens data,
recognize, from the image of the user, a user facial characteristic,
display an optical lens option recommendation and an eyeglasses frames recommendation on the display, the recommendations based on the user responses, the optical lens data, and the user facial characteristic, and
display a modified image of the user based on the image of the user and modified to simulate the appearance of the user wearing the recommended eyeglasses frames with recommended optical lens option.

2. The system of claim 1, wherein said the instructions further include instructions to measure a pupillary distance of the user based on the image; and wherein the optical lens option recommendation and eyeglasses frames recommendation are further based on the pupillary distance.

3. The system of claim 1, wherein said the instructions further include instructions to embed in a store identification, a product identification or an advertisement in the modified image and cause the modified image to be transmitted through a network in email, a mobile device message, or a social media posting.

4. The system of claim 1, wherein the input device is a touch screen.

5. The system of claim 1, further comprising a network interface configured to communicate with an authentication server, a file storage server, an advertiser server, or a social media server.

6. A computerized method for eyewear selection on a computer platform, comprising:
displaying on a computer display prompts for information pertinent to an eyewear frame selection and an optical lens option selection, wherein said eyewear frame selection information comprises results from a user facial characteristics computer-implemented recognition tool, user lifestyle and activities, and one or more of: a photograph of a user trying on frames, a photograph of a simulated frame superimposed on the user, a prescription, user age, user gender, and user personal style preference;
receiving said information through an input device;
displaying on the computer display an eyewear frame recommendation and an optical lens option recommendation based on said results and other received said information; and
receiving through an input device an indication of a frame selection and an optical lens option selection.

7. The method of claim 6, wherein said computer platform is equipped with a camera and said method further comprises:
prompting a user to pose with or without wearing eyeglass frames;
taking a photograph of the user;
permitting the user to select to modify the photograph with selected superimposed simulated frames and/or simulated lenses; and
displaying the photograph of the user.

8. The method of claim 7, further comprising a step of embedding in said photograph a store identification, a product identification or an advertisement.

9. The method of claim 7, further comprising transmission of said photograph through a network connection to a mobile device, an email address or social networking website.

10. The method of claim 6, wherein said optical lens option information comprises two or more of an optical prescription, a user lifestyle and activities, and a photograph of the user modified with a simulation of a optical lens option.

11. The method of claim 6, wherein said optical lens options recommendation are progressives, bifocals, trifocals, UV protections, tints, polarizations, lens coatings or photo chromatic.

12. The method of claim 6, further comprising a step of providing an optician tool including one or more of a segment height and optical center measuring tool, pupillary distance measuring tool, lens thickness estimating tool, prescription transposing tool, progressive lens mark identifying tool, lensometer connection tool, and prescription and eyeglass troubleshooting tool.

13. The method of claim 12, wherein said method includes a further step of providing frame and lens option selection information to a point of sales interface.

14. An optical lens and frame selection process comprising:
providing a network connected computer server configured to receive and respond to requests sent across the network from a network connected user computer platform,
transmitting one or more modules of computer executable program instructions and displayable data to the network connected user computer platform in response to a request, wherein said modules include modules configured to:
a) display prompts for user input information concerning eyeglasses selection, wherein said user input information includes results from a computer-implemented facial characteristic recognition tool,
b) receive indications of user responses to said prompts, and
c) receive and transmit photographic information, and
one or both of:
d) interact with a social media server and
e) receive advertising information for display to the user from a network connected advertising server;
receiving said user input information; and
transmitting a frame recommendation and an optical lens option recommendation based on said results and received indications, including at least indications of user lifestyle and activities, for display by the network connected user computer platform.

15. The process of claim 14, wherein said photographic information includes product information and advertisement.

16. The process of claim 14, wherein said user input information is further selected from the group consisting of a user photograph, a user photograph modified with simulated frames superimposed, a user prescription, user age, user gender, user personal style preference, user lifestyle and activities, and a user photograph modified with a simulation of the appearance of a lens option.
